(19) United States
(12) Patent Application Publication
(10) Pub. No.: US 2025/0076081 A1
(43) Pub. Date: Mar. 6, 2025

(54) VEHICLE SYSTEM

(71) Applicant: Mitsubishi Electric Corporation, Tokyo (JP)

(72) Inventors: Koji IIDA, Tokyo (JP); Kyosuke Konishi, Tokyo (JP); Takumi Sato, Tokyo (JP)

(73) Assignee: Mitsubishi Electric Corporation, Tokyo (JP)

(21) Appl. No.: 18/784,311

(22) Filed: Jul. 25, 2024

(30) Foreign Application Priority Data
Sep. 4, 2023 (JP) 2023-142847

(51) Int. Cl. G01C 21/00

(52) U.S. Cl. CPC G01C 21/3859; B60W 2556/50; B60W 2756/10

(57) ABSTRACT

To provide a vehicle system can shorten the acquisition period of the local map data on the basis of the position of the ego vehicle, and improve the accuracy of vehicle control. A vehicle system transmits position information of an ego vehicle for every position transmission period; transmits local map data and a reference position for every map transmission period; converts relative positions on the basis of the reference position into the positions in an ego vehicle coordinate system on the basis of the position of the ego vehicle, based on newest position information of the ego vehicle, for every conversion period; calculates the vehicle control amount of the ego vehicle using the positions in the ego vehicle coordinate system; and the conversion period is longer than the position transmission period, and shorter than the map transmission period.

### INCORPORATION BY REFERENCE

The disclosure of Japanese Patent Application No. 2023-142847 filed on Sep. 4, 2023 including its specification, claims and drawings, is incorporated herein by reference in its entirety.

### BACKGROUND

The present disclosure relates to a vehicle system.

The technology regarding the traveling support control which supports the vehicle driving using map data has been proposed. For example, the traveling support control is the automatic driving control which drives the ego vehicle automatically, based on traveling environment and map data around the ego vehicle without involvement of the driver, and the driving support control which supports driving of the driver.

For example, in JP 2021-192011 A, using the map data and the position of the ego vehicle, a lane where the ego vehicle is likely to travel in the future is selected as an object lane, only the map data of the object lane is extracted, and the traveling of the ego vehicle is supported based on the extracted map data.

In the JP 2022-108069 A, about the local map data in which map data of an area close to the ego vehicle was extracted based on high precision map data and the position of the ego vehicle, the shape and the size of the area on map to be extracted is changed based on the traveling condition.

### SUMMARY

However, in JP 2021-192011 A and JP 2022-108069 A, data amount is reduced by adding limitation to the map information to be transmitted. That is, type of map information available for the traveling support is limited. When the map data on the basis of the position of the ego vehicle is transmitted, it is necessary to transmit the map data in accordance with movement of the ego vehicle for the vehicle control, so it is necessary to shorten the transmission period. However, there is a limit in shortening the transmission period of map data with much data amount, and it is difficult to shorten the transmission delay with respect to the movement of the ego vehicle.

Then, the purpose of the present disclosure is to provide a vehicle system that can shorten the acquisition period of the local map data on the basis of the position of the ego vehicle, and improve the accuracy of vehicle control, while reducing the acquisition and transmission load of the local map data around the ego vehicle.

A vehicle system according to the present disclosure, including:
a position acquisition unit that acquires position information of an ego vehicle and transmits the position information of the ego vehicle for every position transmission period;
a local map generation unit that generates local map data of a peripheral area of a position of the ego vehicle, based on the position information of the ego vehicle received from the position acquisition unit, and map data; calculates relative positions on a basis of a reference position, as position information included in the local map data; and transmits the local map data and the reference position for every map transmission period;
a coordinate conversion unit that converts the relative positions on the basis of the reference position included in the local map data received from the local map generation unit into positions in an ego vehicle coordinate system on a basis of the position of the ego vehicle, based on the newest position information of the ego vehicle received from the position acquisition unit, for very conversion period; and
a vehicle control unit that calculates a vehicle control amount which controls a traveling of the ego vehicle, using the position in the ego vehicle coordinate system of the local map data,
wherein the conversion period is longer than the position transmission period, and shorter than the map transmission period.

According to the vehicle system according to the present disclosure, since the local map data has much data amount, and the original position information is time-invariant data, the map transmission period is set comparatively long. On the other hand, since the position information of the ego vehicle has little data amount, it is time-variant data according to the movement of the ego vehicle, and the newest information is required for the vehicle control, the position transmission period is set comparatively short. The coordinate conversion requires comparatively much data amount to be converted, but the newest information in accordance with the movement of the ego vehicle is required for the vehicle control. Accordingly, the conversion period is set in accordance with the calculation period of the vehicle control amount. Therefore, the conversion period is longer than the position transmission period, and shorter than the map transmission period. Thereby, by making the map transmission period of the local map data which has much data amount and is time-invariant data the longest, the processing load and the communication load can be reduced. And, by making the position transmission period of the position information of the ego vehicle the shortest, the coordinate conversion for the calculation of the vehicle control amount can be performed using the newest position information of the ego vehicle, and the accuracy of vehicle control can be improved. Since the position of map data are the latitude and the longitude, which express the position of entire earth, a number of digits is large and a data amount is large. On the other hand, since the relative position of the local map data on the basis of the reference position are local difference position data, a number of digits is small, and a data amount to be transmitted can be reduced. Accordingly, the map transmission period can be shortened, and the processing load and the communication load can be reduced. Therefore, while reducing the acquisition and transmission load of the local map data around the ego vehicle, the acquisition period of the local map data of the ego vehicle coordinate system on the basis of the position of the ego vehicle can be shortened, and the accuracy of vehicle control can be improved.

### BRIEF DESCRIPTION OF THE DRAWINGS

FIG. 1 is a schematic block diagram of the vehicle system according to Embodiment 1;

FIG. 2 is a schematic hardware configuration figure of the map transmission apparatus according to Embodiment 1;

FIG. 3 is a schematic hardware configuration diagram of the vehicle control apparatus according to Embodiment 1;

FIG. 4 is a figure for explaining the coordinate conversion according to Embodiment 1;

FIG. 5 is a time chart for explaining each period and processing of each period according to Embodiment 1;

FIG. 6 is a figure showing an example of each position and the coordinate system at times t5 and t6 of FIG. 5 according to Embodiment 1;

FIG. 7 is a figure showing an example of each position and the coordinate system at times t7, t8, and t9 of FIG. 5 according to Embodiment 1;

FIG. 8 is a figure for explaining the division and transmission for each type of map data according to Embodiment 2;

FIG. 9 is a figure for explaining transmission of the local map data of a differential area according to Embodiment 3;

FIG. 10 is a figure for explaining transmission of a plurality of local map data which use the same reference position according to Embodiment 4; and

FIG. 11 is a figure for explaining the change in the range of the peripheral area according to the type of map data according to Embodiment 5.

### DETAILED DESCRIPTION OF THE EMBODIMENTS

### 1. Embodiment 1

A vehicle system 1 according to Embodiment 1 will be explained with reference to drawings. In the present embodiment, the vehicle system 1 is mounted in an ego vehicle.

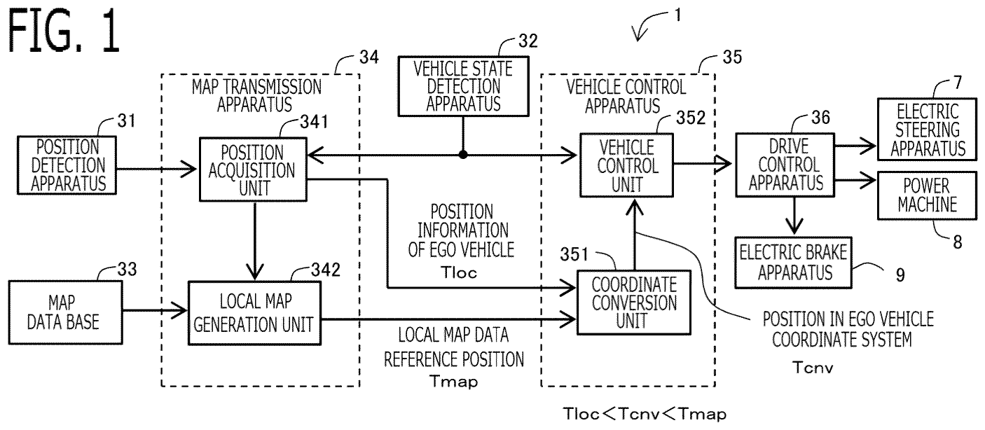

As shown in FIG. 1, the vehicle system 1 is provided with a position detection apparatus 31, a vehicle state detection apparatus 32, a map data base 33, a map transmission apparatus 34, a vehicle control apparatus 35, a drive control apparatus 36, a power machine 8, an electric steering apparatus 7, an electric brake apparatus 9 and the like.

The position detection apparatus 31 detects a present position (latitude, longitude, altitude) of the ego vehicle. As the position detection apparatus 31b, a GNNS antenna which receives signal outputted from satellites such as GNSS (Global Navigation Satellite System), and the like is provided.

The vehicle condition detection apparatus 32 is a detection apparatus which detects an ego vehicle state which is a driving state and a traveling state of the ego vehicle. In the present embodiment, the vehicle state detection apparatus 32 detects an azimuth, a speed, an acceleration, a yaw rate, a steering angle, a lateral acceleration and the like of the ego vehicle, as the traveling state of the ego vehicle. For example, as the vehicle state detection apparatus 32, an azimuth sensor, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 32, an accelerator position sensor, a brake position sensor, a steering angle sensor (handle angle sensor), a steering torque sensor, a direction indicator position switch, and the like are provided.

A position of each part of a ground object around the road and the road is stored in the map data base 33. For example, a position of each part of a lane marking, a position of each part of a road edge, and a position of each sign are stored. The position is a latitude, a longitude, an altitude, and the like. The road edge includes a road shoulder, a roadside wall, a building wall, a fence, a guardrail, a structure of a median strip, a lane segregation mark (a rubber pole, and the like), a delineator, a utility pole, a roadside tree, and the like. The sign includes a traffic signal, a road sign, and the like. Various kinds of information, such as road information (number of lanes, road type, limit speed, and the like), are also stored in the map data base 33. The map data base 33 is mainly constituted of a storage apparatus. The map data base 33 may be provided in a server outside the vehicle connected to the network, and the map transmission apparatus 34 may acquire required road information from the server outside the vehicle via the wireless communication apparatus.

As the drive control apparatus 36, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

### 1-1. Map Transmission Apparatus 34 and Vehicle Control Apparatus 35

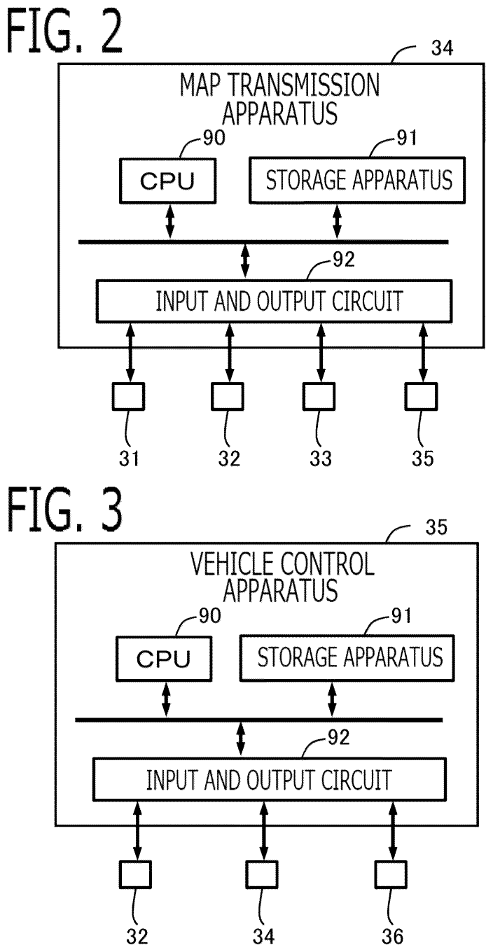

The map transmission apparatus 34 is provided with functional units of a position acquisition unit 341, a local map generation unit 342, and the like. The vehicle control apparatus 35 is provided with functional units of a coordinate conversion unit 351, a vehicle control unit 352, and the like. Each function of the map transmission apparatus 34 and the vehicle control apparatus 35 is realized by the processing circuit provided in each apparatus. Specifically, as shown in FIG. 2 and FIG. 3, each of the map transmission apparatus 34 and the vehicle control apparatus 35 is provided with an arithmetic processor 90 such as CPU (Central Processing Unit), storage apparatuses 91, an input and output circuit 92 which outputs and inputs external signals to the arithmetic 90, and the like. The map transmission apparatus 34 and the vehicle control apparatus 35 communicate with each other, and transmit and receive information. For example, a communications standard such as a CAN (controller area network), Ethernet, or Flex Ray (both registered trademarks) is used for communication.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 of the map transmission apparatus 34 is connected to the position detection apparatus 31, the vehicle state detection apparatus 32, the map data base 33, the vehicle control apparatus 35 and the like, and communicates with these apparatuses. The input and output circuit 92 of the vehicle control apparatus 35 is connected to the vehicle state detection apparatus 32, the drive control apparatus 36, the map transmission apparatus 34 and the like, and communicates with these apparatuses.

Then, the arithmetic processor 90 runs software items (programs) stored in the storage apparatus 91 and collaborates with other hardware devices in each of the map transmission apparatus 34 and the vehicle control apparatus 35, such as the storage apparatus 91, and the input and output circuit 92, so that the respective functions of the functional units 341 and 342 or 351 and 352 provided in each of the map transmission apparatus 34 and the vehicle control apparatus 35 are realized. Various kinds of setting data utilized in the functional units 341 and 342 or 351 and 352 are stored in the storage apparatus 91, such as EEPROM.

The position acquisition unit 341 and the local map generation unit 342 may be provided in a different processing apparatus, respectively, and may be configured to communicate with other processing apparatuses.

### 1-1-1. Position Acquisition Unit 341

The position acquisition unit 341 acquires position information of the ego vehicle, and transmits the position information of the ego vehicle for every position transmission period Tloc. The position information of the ego vehicle includes a latitude lat^{ego}, a longitude lon^{ego}, and an azimuth θ^{ego} of the ego vehicle, and may also include an altitude. The position acquisition unit 341 acquires a position coordinate (latitude, longitude, altitude) of the ego vehicle from the detection information of the GNSS antenna for every position transmission period Tloc. The position acquisition unit 341 acquires the azimuth θ^{ego} of the ego vehicle from the detection information of the azimuth sensor. The azimuth θ^{ego} of the ego vehicle is an angle of a longitudinal direction x of the ego vehicle on the basis of north (north-south direction). In addition to the detection information of the GNSS antenna and the azimuth sensor, the position acquisition unit 341 estimates the position information of the ego vehicle by a composite navigation using the acceleration, the angular speed, and the like which are acquired from the vehicle state detection apparatus 32.

The position acquisition unit 341 transmits the position information of the ego vehicle acquired or estimated for every position transmission period Tloc to the local map generation unit 342, the coordinate conversion unit 351, and the like.

### 1-1-2. Local Map Generation Unit 342

The local map generation unit 342 generates local map data of a peripheral area of the position of the ego vehicle, based on the position information of the ego vehicle received from the position acquisition unit 341, and the map data; calculates relative positions on a basis of a reference position, as position information included in the local map data; and transmits the local map data and the reference position for every map transmission period Tmap. The reference position includes the latitude and the longitude, and may also include the altitude. The relative position includes a relative latitude and a relative longitude on the basis of the reference position (latitude and longitude), and may also include a relative altitude.

The local map generation unit 342 sets the peripheral area including the newest position of the ego vehicle, based on the newest position of the ego vehicle for every map transmission period Tmap. The peripheral area is set to a position range (a range of latitude and longitude) on the basis of the newest position of the ego vehicle. A shape of the position range is set to any shape, such as a rectangle, a circular, an ellipse, or a shape along the road. The local map generation unit 342 acquires the map data of the peripheral area of the position of the ego vehicle from the map data base 33. The local map generation unit 342 sets a reference position based on the position of the ego vehicle. The reference position is set to a position close to the position of the ego vehicle, for example, it is set to the position of the ego vehicle.

The local map generation unit 342 generates the local map data by converting a position of each part included in the map data of the peripheral area of the ego vehicle into the relative position on the basis of the reference position for every map transmission period Tmap. As shown in the next equation, the local map generation unit 342 calculates the relative position (the relative latitude Rlat^{map} and the relative longitude Rlon^{map}) of each part, by subtracting the reference position (the latitude lat_{ref} and the longitude lon^{ref}) from the position (the latitude lat^{map} and the longitude lon^{map}) of each part of the map data of the peripheral area. That is, the relative position is the relative latitude and the relative longitude in which the reference position is set as the origin.

$$\begin{matrix}[ Math . 1 ] & \\ [ \begin{matrix}{Rlat}^{map} \\ {Rlon}^{map}\end{matrix} ] = [ \begin{matrix}{lat}^{map} \\ {lon}^{map}\end{matrix} ] - [ \begin{matrix}{lat}^{ref} \\ {lon}^{ref}\end{matrix} ] & ( 1 )\end{matrix}$$

For example, a position of each part of a lane marking, a position of each part of a road edge, a position of each sign, and the like, which are included in the map data of the peripheral area of the ego vehicle, are converted into the relative positions on the basis of the reference position.

Since the position of map data are the latitude and the longitude, which express the position of entire earth, a number of digits is large and a data amount is large. On the other hand, since the relative position of the local map data on the basis of the reference position are local difference position data, a number of digits is small, and a data amount to be transmitted can be reduced.

The local map generation unit 342 transmits the local map data and the reference position which were generated, to the coordinate conversion unit 351 and the like for every map transmission period Tmap.

### 1-1-3. Coordinate Conversion Unit 351

The coordinate conversion unit 351 converts the relative positions on the basis of the reference position included in the local map data received from the local map generation unit 342 into positions in an ego vehicle coordinate system on the basis of the position of the ego vehicle, based on the newest position information on the ego vehicle received from the position acquisition unit 341, for very conversion period Tcnv.

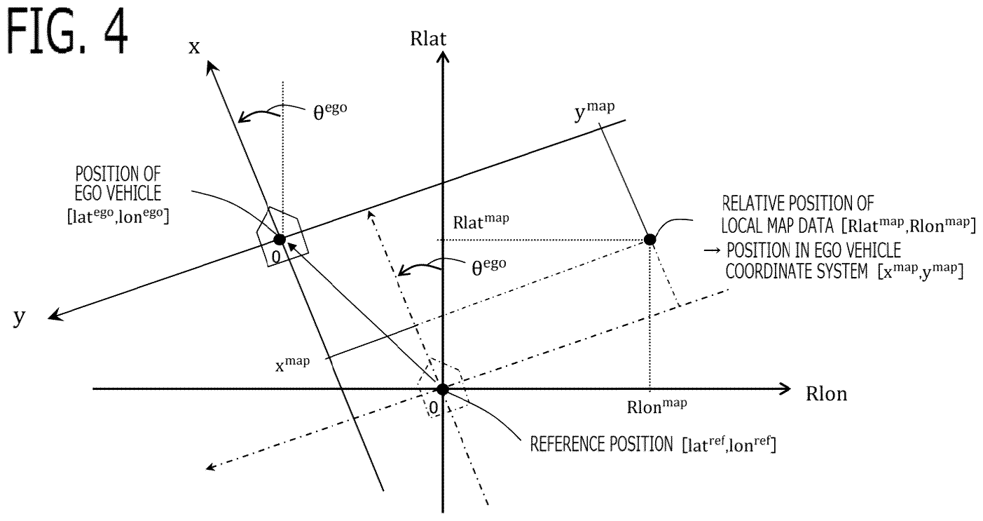

As shown in FIG. 4 and the next equation, the coordinate conversion unit 351 converts the relative position (the relative latitude Rlat^{map} and the relative longitude Rlon^{map}) on the basis of the reference position of each part included in local map data into the position in the ego vehicle coordinate system (the longitudinal position x^{map}, the lateral position y^{map}), by performing a rotating coordinate conversion and a movement conversion based on the newest position information on the ego vehicle (the latitude lat^{ego}, the longitude lon^{ego}, the azimuth ego, and the reference position (the longitude lat^{ref}, the longitude lon^{ref}).

$$\begin{matrix}[ Math . 2 ] & \\ [ \begin{matrix}{x}^{map} \\ - {y}^{map}\end{matrix} ] = [ \begin{matrix}cos ( {θ}^{ego} ) & sin ( {θ}^{ego} ) \\ - sin ( {θ}^{ego} ) & cos ( {θ}^{ego} )\end{matrix} ] [ \begin{matrix}{Rlat}^{map} \\ {Rlon}^{map}\end{matrix} ] - [ \begin{matrix}cos ( {θ}^{ego} ) & sin ( {θ}^{ego} ) \\ - sin ( {θ}^{ego} ) & cos ( {θ}^{ego} )\end{matrix} ] \{ [ \begin{matrix}{lat}^{ego} \\ {lon}^{ego}\end{matrix} ] - [ \begin{matrix}{lat}^{ref} \\ {lon}^{ref}\end{matrix} ] \} & ( 2 )\end{matrix}$$

Herein, the position in the ego vehicle coordinate system is a position in the longitudinal direction (longitudinal position x^{map}) of the ego vehicle and a position in the lateral direction (lateral position y^{map}) of the ego vehicle, on the basis of the ego vehicle. The origin of the ego vehicle coordinate system is set at the position of the ego vehicle.

### 1-1-4. Vehicle Control Unit 352

The vehicle control unit 352 calculates a vehicle control amount which controls a traveling of the ego vehicle, using the position in the ego vehicle coordinate system of the local map data, and transmits the vehicle control amount to the drive control apparatus 36. The drive control apparatus 36 controls a traveling of the ego vehicle. The vehicle control unit 352 calculates the vehicle control amount for every vehicle control period Tvc. For example, the vehicle control period Tvc may be set the same as the conversion period Tcnv, and the calculation processing of the vehicle control amount may be performed after the conversion processing of the coordinate conversion unit 351.

For example, the vehicle control unit 352 performs a driving assistance of driver or an automated driving, based on the position in the ego vehicle coordinate system, such as the lane marking and the sign included in local map data. For example, the vehicle control unit 352 determines an ego lane where the ego vehicle is traveling; calculates a target steering angle for traveling along the ego lane, or a target steering angle for changing lanes to an adjacent lane of the ego lane; and transmits a target steering angle to the drive control apparatus 36 (the automatic steering controller). The vehicle control unit 352 may determine a target speed, an operation command of the direction indicator, and the like, and may transmit to the drive control apparatus 36 (the power controller, the brake controller, the light controller, and the like).

The power controller controls output of the power machine 8, such as the internal combustion engine and the motor, so that the speed of the ego vehicle follows the target speed. The brake controller controls the brake operation of the electric brake apparatus 9 so that the speed of the ego vehicle follows the target speed. The automatic steering controller controls the electric steering apparatus 7 so that the steering angle follows the target steering angle. The light controller controls the direction indicator according to the operation command of the direction indicator.

The vehicle control unit 352 may detect other vehicle, an obstacle, and the like around the ego vehicle, using the detection information of the periphery monitoring apparatus, such as the camera and the radar, and may use for the driving assistance or the automated driving. For example, as the control of vehicle, a lane keeping control, an obstacle avoidance control, a lane change control, a cruise control, a vehicle distance control, a preceding vehicle tracking control, and the like are performed.

The vehicle control unit 352 may perform various kinds of guidance (for example, a route guide, a guidance of peripheral information, a guidance of danger) to the driver via the display or the loudspeaker, based on various kinds of position information included in the local map data.

### 1-1-5. Setting of Each Period

The conversion period Tcnv is longer than the position transmission period Tloc, and shorter than the map transmission period Tmap.

Since the local map data has much data amount, and the original position information is time-invariant data, the map transmission period Tmap is set comparatively long. On the other hand, since the position information of the ego vehicle has little data amount, it is time-variant data according to the movement of the ego vehicle, and the newest information is required for the vehicle control, the position transmission period Tloc is set comparatively short. The coordinate conversion requires comparatively much data amount to be converted, but the newest information in accordance with the movement of the ego vehicle is required for the vehicle control. Accordingly, the conversion period Tcnv is set in accordance with the calculation period of the vehicle control amount. Therefore, the conversion period Tcnv is longer than the position transmission period Tloc, and shorter than the map transmission period Tmap. Thereby, by making the map transmission period Tmap of the local map data which has much data amount and is time-invariant data the longest, the processing load and the communication load can be reduced. And, by making the position transmission period Tloc of the position information of the ego vehicle the shortest, the coordinate conversion for the calculation of the vehicle control amount can be performed using the newest position information of the ego vehicle, and the accuracy of vehicle control can be improved.

Since the position of map data are the latitude and the longitude, which express the position of entire earth, a number of digits is large and a data amount is large. On the other hand, since the relative position of the local map data on the basis of the reference position are local difference position data, a number of digits is small, and a data amount to be transmitted can be reduced. Accordingly, the map transmission period Tmap can be shortened, and the processing load and the communication load can be reduced.

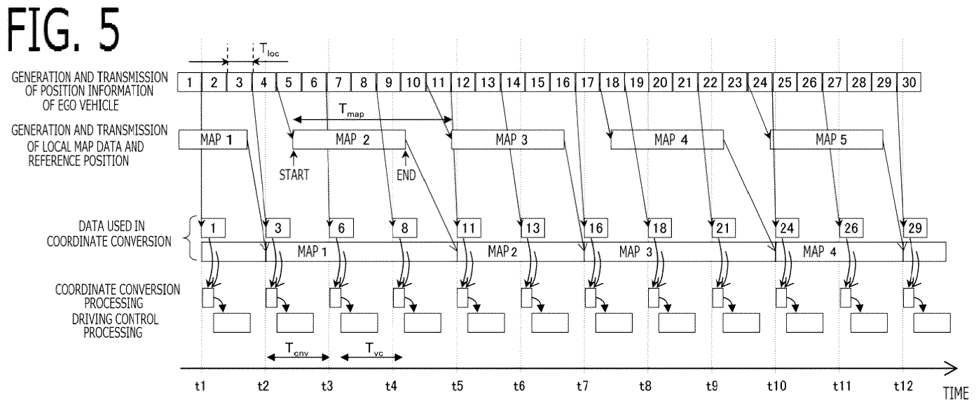

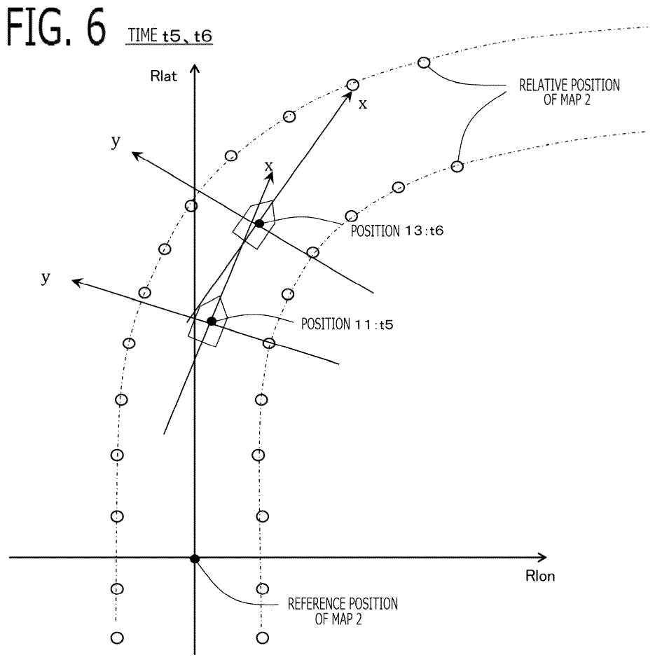

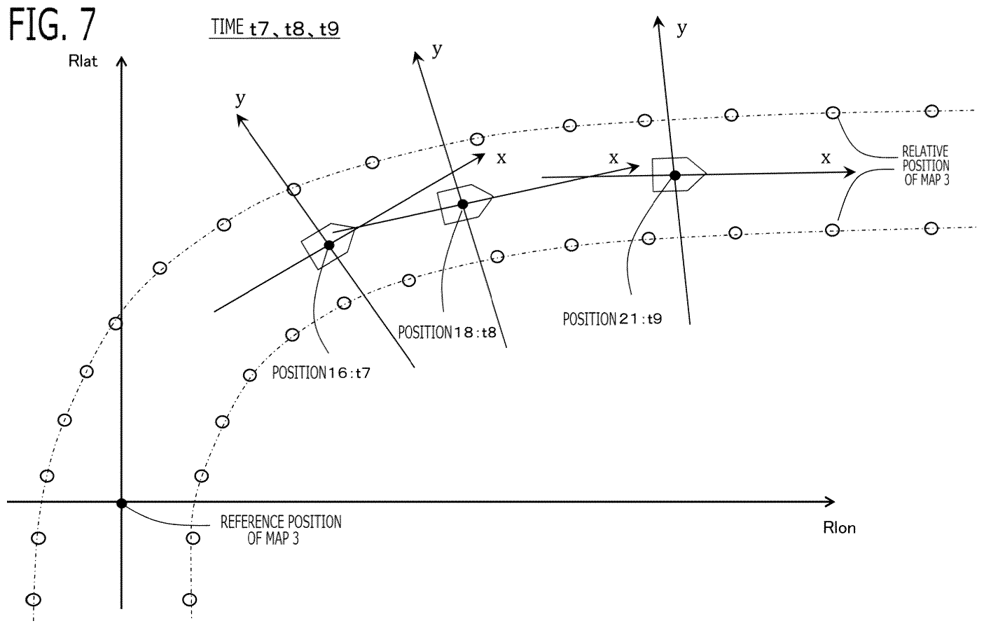

FIG. 5 shows a time chart for explaining each period and processing of each period. FIG. 6 shows an example of each position and the coordinate system at time t5 and t6 of FIG. 5. FIG. 7 shows an example of each position and the coordinate system at time t7, t8, and t9 of FIG. 5.

The position transmission period Tloc is set the shortest, and the map transmission period Tmap is set the longest. And, the conversion period Tcnv is set longer than the position transmission period Tloc, and is set shorter than the map transmission period Tmap in accordance with the vehicle control period Tvc.

The position transmission period Tloc is the shortest and the newest position information of the ego vehicle is always used for the conversion processing. On the other hand, the map transmission period Tmap is longer than the position transmission period Tloc and the conversion period Tcnv, and there are cases where the same local map data used for the previous conversion processing is used for the present conversion processing. However, since the original position information of the map data is time-invariant, there is no problem, and the processing load and the communication load can be reduced. The map transmission period Tmap is set shorter than a period until the position of the ego vehicle deviates from the range of the local map data transmitted previously.

The conversion period Tcnv is made the same as the vehicle control period Tvc, and the conversion processing of the coordinate conversion unit 351 is performed just before the calculation processing of the vehicle control amount. Accordingly, since the vehicle control amount is calculated using the position information in the ego vehicle coordinate system in which the coordinate conversion was performed using the newest position information of the ego vehicle, the accuracy of vehicle control can be improved.

As shown in FIG. 6, in the coordinate conversion at time t5 and time t6, the map 2 which is the same local map data is used. However, since it is time-invariant data, there is no problem. Since the position 11 which is the newest position of the ego vehicle is used for the coordinate conversion at time t5, and the position 13 which is the newest position of the ego vehicle is used for the coordinate conversion at time t6, the coordinate conversion can be performed using the newest position information of the ego vehicle, and the accuracy of vehicle control can be improved.

As shown in FIG. 7, in the coordinate conversion at times t7, t8, and t9, the map 3 which is the new local map data is acquired, and it is used for the coordinate conversion. The reference position of the map 3 is moved in accordance with the movement of the ego vehicle, the map data around the ego vehicle can be used. Although the map 3 which is the same local map data is used in the coordinate conversion at times t7, t8, and t9, there is no problem since the peripheral area where the map data was acquired is set appropriately in accordance with the movement of the ego vehicle, and it is time-invariant data. Since the position 16 which is the newest position of the ego vehicle is used for the coordinate conversion at time t7, the position 18 which is the newest position of the ego vehicle is used for the coordinate conversion at time t8, and the position 21 which is the newest position of the ego vehicle is used for the coordinate conversion at time t9, the coordinate conversion is performed using the newest position information of the ego vehicle, and the accuracy of vehicle control can be improved.

### 2. Embodiment 2

Next, the vehicle system 1 according to Embodiment 2 will be explained. The explanation for constituent parts the same as those in Embodiment 1 will be omitted. The basic configuration of the vehicle system 1 according to the present embodiment is the same as that of Embodiment 1. Embodiment 2 is different from Embodiment 1 in the generation method and the transmission method of the local map data in the local map generation unit 342.

In the present embodiment, the local map generation unit 342 divides the local map data and the reference position to transmit for every map transmission period Tmap.

According to this configuration, instead of transmitting all local map data in one map transmission period Tmap, the local map data is divided and transmitted in a plurality of map transmission periods Tmap. Accordingly, the processing and the communication per one map transmission period Tmap can be reduced, and the processing load and the communication load can be reduced.

In the present embodiment, the local map generation unit 342 divides the local map data and the reference position for each type of map data, and transmits for every map transmission period Tmap.

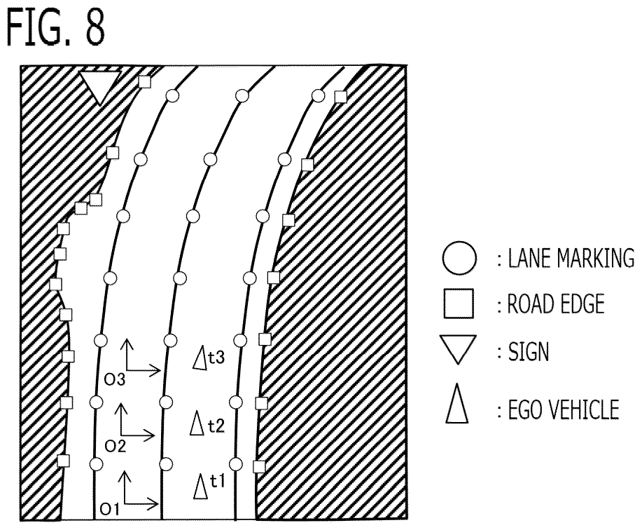

For example, as shown in FIG. 8, as the type of map data, the lane marking, the road edge, and the sign are used. The local map generation unit 342 generates and transmits the local map data of the lane marking, the local map data of the road edge, and the local map data of the sign in order, for every map transmission period Tmap.

For example, at time t1, the local map generation unit 342 sets the reference position O1 and the peripheral area of the ego vehicle, based on the newest position information of the ego vehicle acquired at time t1; and converts the position of each part of the lane marking included in the peripheral area map data of the ego vehicle into the relative position on the basis of the reference position O1, generates the local map data of the lane marking, and transmits the local map data of the lane marking and the reference position O1. At time t2, the local map generation unit 342 sets the reference position O2 and the peripheral area of the ego vehicle, based on the newest position information of the ego vehicle acquired at time t2; and converts the position of each part of the road edge included in the peripheral area map data of the ego vehicle into the relative position on the basis of the reference position O2, generates the local map data of the road edge, and transmits the local map data of the road edge and the reference position O2. At time t3, the local map generation unit 342 sets the reference position O3 and the peripheral area of the ego vehicle, based on the newest position information of the ego vehicle acquired at time t3, converts the position of each part of the road edge included in the peripheral area map data of the ego vehicle into the relative position on the basis of the reference position O3, generates the local map data of the road edge, and transmits the local map data and the reference position O3 of the road edge.

The coordinate conversion unit 351 converts the relative positions of the plurality of local map data which were divided and received from the local map generation unit 342 into the positions in the ego vehicle coordinate system on the basis of the position of the ego vehicle, based on the newest position of the ego vehicle received from the position acquisition unit 341, for every conversion period Tcnv. In the present embodiment, in the same conversion period Tcnv, the coordinate conversion unit 351 converts the relative positions of the local map data of the all types of map data into the positions in the ego vehicle coordinate system, based on the newest position of the ego vehicle and the reference position of each local map data. For example, in the same conversion period Tcnv, the coordinate conversion unit 351 converts the relative positions of the newest local map data of the lane marking into the positions in the ego vehicle coordinate system, based on the newest position of the ego vehicle and the reference position of the newest local map data of the lane marking; converts the relative positions of the newest local map data of the road edge into the positions in the ego vehicle coordinate system, based on the newest position of the ego vehicle and the reference position of the newest local map data of the road edge; and converts the relative positions of the newest local map data of the sign into the positions in the ego vehicle coordinate system, based on the newest position of the ego vehicle and the reference position of the newest local map data of the sign.

### 3. Embodiment 3

Next, the vehicle system 1 according to Embodiment 3 will be explained. The explanation for constituent parts the same as that of Embodiment 1 or 2 will be omitted. The basic configuration of the vehicle system 1 according to the present embodiment is the same as that of Embodiment 1 or 2. Embodiment 3 is different from Embodiment lor 2 in the generation method and the transmission method of the local map data in the local map generation unit 342.

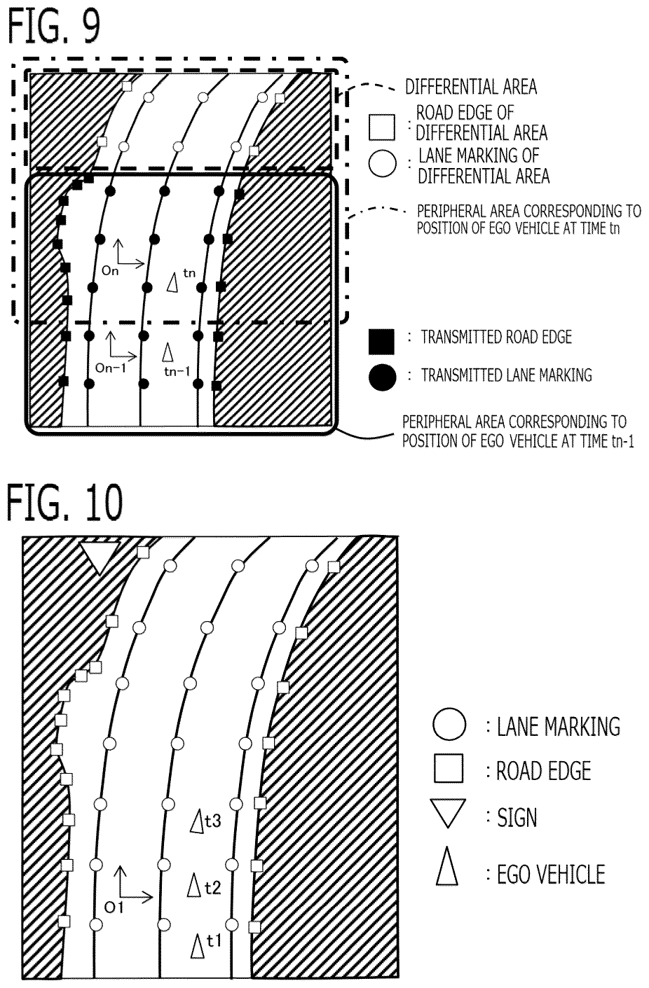

In the present embodiment, as shown in FIG. 9, in the present map transmission period Tmap, the local map generation unit 342 transmits the local map data and the reference position of a differential area which is not included in an area of the local map data transmitted in the past map transmission period Tmap among the peripheral area of the position of the ego vehicle. The coordinate conversion unit 351 converts the relative positions on the basis of the reference position included in the local map data transmitted in the newest map transmission period Tmap, and the relative positions on the basis of the reference position included in the local map data transmitted in the past map transmission period Tmap, into the positions in the ego vehicle coordinate system.

According to this configuration, since the local map data of the differential area between the past transmission areas and the peripheral area of the present position of the ego vehicle is transmitted, the redundant data transmission can be reduced, the map transmission period Tmap can be shortened, and the processing load and the communication load can be reduced.

The local map data and the reference position which were transmitted in the past are stored in the storage apparatus, such as RAM. Unnecessary past local map data and reference position are successively deleted from the storage apparatus.

In the same conversion period Tcnv, the coordinate conversion unit 351 extracts the local map data and the reference positions of the peripheral area corresponding to the newest position of the ego vehicle from the local map data and the reference positions transmitted in the past; converts the extracted past local map data into the positions in the ego vehicle coordinate system, based on the newest position of the ego vehicle and the reference positions of the past local map data, and converts the local map data of the newest differential area into the positions in the ego vehicle coordinate system, based on the newest position of the ego vehicle and the reference position of the local map data of the newest differential area.

Similar to Embodiment 2, the local map generation unit 342 may transmit the local map data and the reference position of the differential area for each type of map data.

### 4. Embodiment 4

Next, the vehicle system 1 according to Embodiment 4 will be explained. The explanation for constituent parts the same as those in Embodiment 1 will be omitted. The basic configuration of the vehicle system 1 according to the present embodiment is the same as that of Embodiment 1. Embodiment 4 is different from Embodiment 1 in the generation method and the transmission method of the local map data in the local map generation unit 342.

In the present embodiment, the local map generation unit 342 sets the same reference position between a plurality of the local map data and the reference positions which are divided and transmitted in a plurality of the map transmission periods Tmap. The coordinate conversion unit 351 converts the relative positions of the plurality of newest local map data in which the same reference position was set, based on the newest position of the ego vehicle and the same reference position.

According to this configuration, in the coordinate conversion of the coordinate conversion unit 351, the plurality of divided local map data can be converted using the same coordinate conversion equation in which the same reference position is set, and the arithmetic processing load can be reduced. Specifically, the calculation value of movement conversion of the right side second term of the equation (2) becomes the same, and the arithmetic processing load can be reduced.

Similar to Embodiment 2, the local map generation unit 342 divides the local map data and the reference position for each type of map data and transmits for every map transmission period Tmap. For example, as the type of map data, the lane marking, the road edge, and the sign are used.

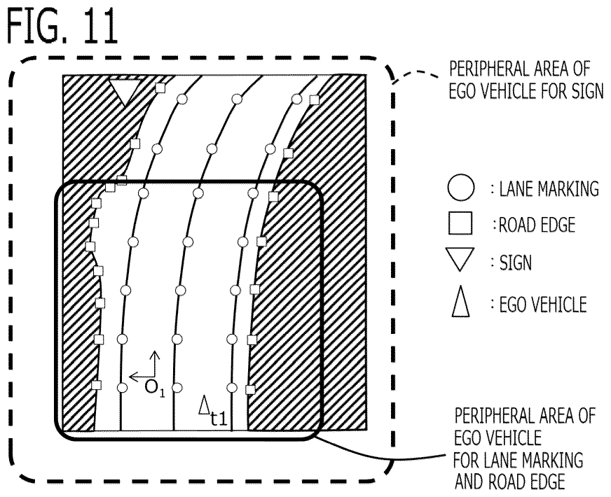

As shown in FIG. 10, the same reference position O1 is used among the local map data of the lane marking, the local map data of the road edge, and the local map data of the sign which were divided and transmitted in three map transmission periods Tmap. Then, in next three map transmission periods Tmap, the new same reference position is set, and the local map data of the lane marking, the road edge, and the sign are transmitted. The coordinate conversion unit 351 converts the newest relative positions of the local map data of the lane marking, the road edge, and the sign in which the same reference position was set, into the positions in the ego vehicle coordinate system, based on the newest position of the ego vehicle and the same reference position.

Alternatively, in Embodiment 3, the local map generation unit 342 may set the same reference position among the local map data and the reference positions of a plurality of differential areas transmitted in present and past map transmission periods Tmap. For example, the local map generation unit 342 changes the reference position for every prescribed number of map transmission periods Tmap. The coordinate conversion unit 351 converts the relative positions of the local map data of the plurality of differential areas in which the same reference position was set, into the positions in the ego vehicle coordinate system, based on the newest position of the ego vehicle and the same reference position.

According to this configuration, in the coordinate conversion of the coordinate conversion unit 351, the local map data of the plurality of differential areas can be converted using the same coordinate conversion equation in which the same reference position was set, and the arithmetic processing load can be reduced. Specifically, the calculation value of movement conversion of the right side second term of the equation (2) becomes the same, and the arithmetic processing load can be reduced.

### 5. Embodiment 5

Next, the vehicle system 1 according to Embodiment 5 will be explained. The explanation for constituent parts the same as those in Embodiment 1 will be omitted. The basic configuration of the vehicle system 1 according to the present embodiment is the same as that of Embodiment 1. Embodiment 5 is different from Embodiment 1 in the generation method and the transmission method of the local map data in the local map generation unit 342.

The local map generation unit 342 changes a range of the peripheral area where each type of data included in the local map data or the local map data is generated, according to at least one of a type of map data included in the local map data, a speed of the ego vehicle, and a road type.

According to this configuration, according to at least one of the type of map data, the speed of the ego vehicle, and the road type, the range of the peripheral area is changed appropriately, and the processing load and the communication load can be optimized.

For example, when the lane marking, the road edge, and the sign are used as the type of map data, the range of the peripheral area of the each type of map data may be changed according to the lane marking, the road edge, and the sign. As shown in FIG. 11, since the lane marking and the road edge have much data amount, the range of the peripheral area is set narrowly. Since the sign has little data amount, the range of the peripheral area is set widely. The local map generation unit 342 transmits the local map data in which the peripheral area is changed for each type of map data, for every map transmission period Tmap.

As the speed of the ego vehicle becomes fast, the range of the peripheral area is expanded. As the speed of the ego vehicle becomes fast, a traveling distance of the ego vehicle during the map transmission periods Tmap becomes long, and the required range of the peripheral area is expanded. Accordingly, the appropriate range of the peripheral area can be set.

The required range of the peripheral area is changed according to the road type, such as a highway and an ordinary road, and the appropriate range of the peripheral area can be set.

The type of map data, the speed of the ego vehicle, and the road type may be combined, and the range of the peripheral area may be changed. For example, the range of the peripheral area for each type of map data may be changed according to the speed of the ego vehicle.

### 6. Embodiment 6

Next, the vehicle system 1 according to Embodiment 6 will be explained. The explanation for constituent parts the same as those in Embodiment 1 will be omitted. The basic configuration of the vehicle system 1 according to the present embodiment is the same as that of Embodiment 1. Embodiment 6 is different from Embodiment 1 in the generation method and the transmission method of the local map data in the local map generation unit 342.

The local map generation unit 342 changes the map transmission period Tmap of each type of map data included in the local map data, or the map transmission period Tmap of the local map data, according to at least one of the type of map data included in the local map data, the speed of the ego vehicle, and the road type.

According to this configuration, according to at least one of the type of map data, the speed of the ego vehicle, and the road type, the map transmission period Tmap of each type of map data or the map transmission period Tmap of the local map data is changed appropriately, and the processing load and the communication load can be optimized.

For example, when the lane marking, the road edge, and the sign are used as the type of map data, the map transmission period Tmap of the local map data of the lane marking, the map transmission period Tmap of the local map data of the road edge, and the map transmission period Tmap of the local map data of the sign are changed. For example, the map transmission periods Tmap of the lane marking and the road edge which require frequent updating for the traveling control of the ego vehicle are set short. And, the map transmission period Tmap of the sign which does not require frequent updating is set long.

As the speed of the ego vehicle becomes fast, the map transmission period Tmap of the local map data is set short. As the speed of the ego vehicle becomes fast, the traveling distance of the ego vehicle per unit time becomes long, and frequent transmission is required. Accordingly, the appropriate map transmission period Tmap can be set.

The required map transmission period Tmap is changed according to the road type, such as the highway and the ordinary road, and the appropriate map transmission period Tmap can be set.

The type of map data, the speed of the ego vehicle, and the road type may be combined, and the transmission period Tmap may be changed. For example, the transmission period Tmap for each type of map data may be changed according to the speed of the ego vehicle.

### 7. Embodiment 7

Next, the vehicle system 1 according to Embodiment 7 will be explained. The explanation for constituent parts the same as those in Embodiment 1 will be omitted. The basic configuration of the vehicle system 1 according to the present embodiment is the same as that of Embodiment 1. Embodiment 7 is different from Embodiment 1 in the processing of the coordinate conversion unit 351.

The coordinate conversion unit 351 changes the conversion period Tcnv of each type of map data included in the local map data, according to the type of map data included in the local map data.

According to this configuration, according to the type of map data, the conversion period Tcnv of each type of map data is changed appropriately, and the processing load can be optimized.

For example, when the lane marking, the road edge, and the sign are used as the type of map data, the conversion period Tcnv of the map data of the lane marking, the conversion period Tcnv of the map data of the road edge, and the conversion period Tcnv of the map data of the sign are changed. For example, the conversion periods Tcnv of the lane marking and the road edge which require frequent updating for the traveling control of the ego vehicle are set short. And, the conversion period Tcnv of the sign which does not require frequent updating is set long. For example, the map data of the lane marking and the road edge are converted for every conversion period Tcnv which is the same as the vehicle control period Tvc. And, the map data of the sign is converted for every prescribed number of conversion periods Tcnv.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A vehicle system comprising at least one processor configured to implement:
a position acquisitor that acquires position information of an ego vehicle and transmits the position information of the ego vehicle for every position transmission period;
a local map generator that generates local map data of a peripheral area of a position of the ego vehicle, based on the position information of the ego vehicle received from the position acquisitor, and map data; calculates relative positions on a basis of a reference position, as position information included in the local map data; and transmits the local map data and the reference position for every map transmission period;
a coordinate converter that converts the relative positions on the basis of the reference position included in the local map data received from the local map generator into positions in an ego vehicle coordinate system on a basis of the position of the ego vehicle, based on the newest position information of the ego vehicle received from the position acquisitor, for very conversion period; and
a vehicle controller that calculates a vehicle control amount which controls a traveling of the ego vehicle, using the position in the ego vehicle coordinate system of the local map data,
wherein the conversion period is longer than the position transmission period, and shorter than the map transmission period.

2. The vehicle system according to claim 1,
wherein the local map generator divides the local map data and the reference position to transmit for the every map transmission period.

3. The vehicle system according to claim 1,
wherein, in the present map transmission period, the local map generator transmits the local map data and the reference position of a differential area which is not included in an area of the local map data transmitted in the past map transmission periods among the peripheral area of the position of the ego vehicle, and
wherein the coordinate converter converts the relative positions on the basis of the reference position included in the local map data transmitted in the newest map transmission period, and the relative positions on the basis of the reference position included in the local map data transmitted in the past map transmission periods, into the positions in the ego vehicle coordinate system.

4. The vehicle system according to claim 2,
wherein the local map generator sets the same reference position between a plurality of the local map data and the reference positions which are divided and transmitted in a plurality of the map transmission periods.

5. The vehicle system according to claim 3,
wherein the local map generator sets the same reference position between the local map data and the reference positions of a plurality of the differential areas which are transmitted in the present and past map transmission periods.

6. The vehicle system according to claim 1,
wherein the local map generator changes a range of the peripheral area where each type of data included in the local map data or the local map data is generated.

7. The vehicle system according to claim 1,
wherein the local map generator changes a range of the peripheral area where each type of data included in the local map data or the local map data is generated, according to at least one of a type of map data included in the local map data, a speed of the ego vehicle, and a road type.

8. The vehicle system according to claim 1,
wherein the local map generator changes the map transmission period of each type of map data included in the local map data, or the map transmission period of the local map data.

9. The vehicle system according to claim 1,
wherein the local map generator changes the map transmission period of each type of map data included in the local map data, or the map transmission period of the local map data, according to at least one of a type of map data included in the local map data, a speed of the ego vehicle, and a road type.

10. The vehicle system according to claim 1,
wherein the coordinate converter changes the conversion period of each type of map data included in the local map data.

11. The vehicle system according to claim 1,
wherein the coordinate converter changes the conversion period of each type of map data included in the local map data, according to the type of map data included in the local map data.
